(19) United States
(12) Patent Application Publication
(10) Pub. No.: US 2007/0171165 A1
(43) Pub. Date: Jul. 26, 2007

(54) Devices and methods for controlling timing sequences for displays of such devices

(76) Inventors: Ching-Yun Chuang, Tainan City (TW); Chung-Wen Lai, Yingge Township (TW); Szu-Hsien Lee, Kaohsiung City (TW); Fu-Chih Chang, Changhua City (TW); Norio Oku, Taipei City (JP); Li-Seu Chuang, Penghu (TW); Wen-Chieh Teng, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/339,358

(22) Filed: Jan. 25, 2006

(51) Int. Cl. G09G 3/36

(52) U.S. Cl. 345/88

(57) ABSTRACT

Methods for controlling display panels, in which the display panel comprises a plurality of pixels and wherein each of the plurality of pixels comprises a plurality of sub-pixels, are provided. A representative the method comprises: controlling a timing sequence for turning on the pixels such that at least one of: an average influence of coupling of each of the sub-pixels in two sequential time frames is the same; and an average influence of coupling of two of the sub-pixels on two adjacent rows of the sub-pixels is the same.

### BACKGROUND OF THE INVENTION

1. Field of the Invention

The present invention relates to controlling of pixels of display devices.

2. Description of Related Art

FIG. 1 is a schematic view of a conventional liquid crystal display (LCD). As shown in FIG. 1, a conventional LCD panel 100 generally includes a gate driver 102, a source driver 104 and a display area 106. The display area 106 includes a pixel array constructed by a plurality of pixels. For example, a conventional display area with 1024×768 resolution has 1024 columns and 768 rows of pixels, such as the pixels 112, 114, 126, 122, 124, 126 and so on shown in FIG. 1. In addition, each pixel has a red sub-pixel, a green sub-pixel and a blue sub-pixel. For example, the pixel 112 in the first row and first column of the display area 106 has a red sub-pixel 112r, a green sub-pixel 112g, and a blue sub-pixel 112b. Therefore, the display area 106 has 3072 columns and 768 rows of sub-pixels.

In FIG. 1, each sub-pixel has a thin film transistor (TFT) and a capacitor, wherein the capacitor is connected between the drain of the TFT and the common electrode. The gate of each TFT is connected to and controlled by the gate driver 102 via a corresponding scan line. In addition, the source of the TFT is connected to and controlled by the source driver 104 via a corresponding data line. Conventionally, the gate driver 102 generates a plurality of scan signals that are provided to the scan lines. Therefore, when one of the scan lines (e.g., the first scan line) receives the scan signal, all the TFTs connected to the first scan line (e.g., the TFTs of the sub-pixels 112r, 112g, 112b, 114r, 114g, 114b and so on) will be turned on, and the data signals may be stored in the capacitors connected to the TFTs.

Conventionally, the number of the source lines of the display area is three times the number of the pixels in each column of the display area since each pixel of the display area has three sub-pixels (e.g., as described above, the 1024×768 resolution display area has 3072 scan lines). In addition, the total pin number of the integrated circuit (IC) of the source driver has to be equal to or greater than the number of the source lines. Therefore, the bonding between the scan lines of the conventional display area and the pins of the source driver is complex and time consuming. Accordingly, it is important to reduce the number of the source lines of the display area and the pin number of the source driver.

FIG. 2 is a schematic view of another conventional LCD device. As shown in FIG. 2, LCD device 200 comprises a gate driver device 202, a source driver device 204 and a display area 206. The display area 206 comprises a multiplexer device 208 and a plurality of pixels such as 212, 214, 216, 218, 220, 222, 232, 234, 236, 238, 240, 242, and so on. Moreover, each pixel of the display area comprises a red sub-pixel, a green sub-pixel and a blue sub-pixel. For example, the pixel 216 comprises a red sub-pixel 216r, a green sub-pixel 216g and a blue sub-pixel 216b.

The multiplexer device 208 is disposed in the display area and connected between the data lines of the sub-pixels and the pins of the source driver device 204. The multiplexer device 208 comprises a plurality of multiplexers such as multiplexers 222, 224, 226 and so on. Each multiplexer comprise 6 switches. For example, the multiplexer 224 comprises transistors 224a, 224b, 224c, 224d, 224e and 224f, wherein the source (or drain) of the transistors 224a, 224b, 224c, 224d, 224e and 224f may be connected to the drain of TFTs of the sub-pixels 216r, 216g, 216b, 218r, 218g and 218b via the corresponding data lines

However, for any two adjacent sub-pixels, the one that is turned on later in time may be electrically coupled to the other. Therefore, the charges stored in the capacitor of the sub-pixel that is turned on later in time may be influenced by the other sub-pixel. Accordingly, because a typical turn on sequence controlled by the control device 210 of the prior art is RGBRGB, i.e., the turn on sequence is started from transistor 224a, sequentially followed by transistors 224b, 224c, 224d, 224e and 224f, the coupled charge on the capacitor of sub-pixel 216r may be twice as much as those on the capacitor of sub-pixels 216g, 216b, 218r and 218g, and the coupled charge on the capacitor of sub-pixel 218b is zero. Unfortunately, the different coupled charges between the same colored sub-pixels (for example, 216r and 218r) can make the display non-uniform even when displaying a pure color.

### SUMMARY OF THE INVENTION

Methods for controlling display panels, in which the display panel comprises a plurality of pixels and wherein each of the plurality of pixels comprises a plurality of sub-pixels, are provided. An exemplary embodiment of such a method comprises: controlling a timing sequence for turning on the pixels such that at least one of: an average influence of coupling of each of the sub-pixels in two sequential time frames is the same; and an average influence of coupling of two of the sub-pixels on two adjacent rows of the sub-pixels is the same.

Devices also are provided. In this regard, an exemplary embodiment of such a device comprises: a display device comprising a plurality of pixels, each of the plurality of pixels having sub-pixels, the display device being operative to illuminate the sub-pixels in accordance with a timing sequence, the timing sequence being configured such that at least one of: an average influence of coupling of each of the sub-pixels in two sequential time frames is the same; and an average influence of coupling of two of the sub-pixels on two adjacent rows of the sub-pixels is the same.

It is to be understood that both the foregoing general description and the following detailed description are exemplary, and are intended to provide further explanation of the invention as claimed.

### BRIEF DESCRIPTION OF THE DRAWINGS

The drawings illustrate embodiments of the invention and, together with the description, serve to explain the principles of the invention.

FIG. 1 is a schematic view of a conventional liquid crystal display device.

FIG. 2 is a schematic view of another conventional liquid crystal display device.

FIG. 3A is a schematic view of a liquid crystal display device according to one embodiment of the present invention.

FIG. 3B and FIG. 3C are timing diagrams of a driving method of the sub-pixels according to one embodiment of the present invention.

FIG. 4A and FIG. 4B are timing diagrams of a driving method of the sub-pixels according to another embodiment of the present invention.

FIG. 5A and FIG. 5B are timing diagrams of a driving method of the sub-pixels according to another embodiment of the present invention.

FIG. 6A and FIG. 6B are timing diagrams of a driving method of the sub-pixels according to another embodiment of the present invention.

FIG. 7A and FIG. 7B are timing diagrams of a driving method of the sub-pixels according to another embodiment of the present invention.

FIG. 8A and FIG. 8B are timing diagrams of a driving method of the sub-pixels according to another embodiment of the present invention.

FIG.9 is a block diagram of an electronic device according to one embodiment of the present invention.

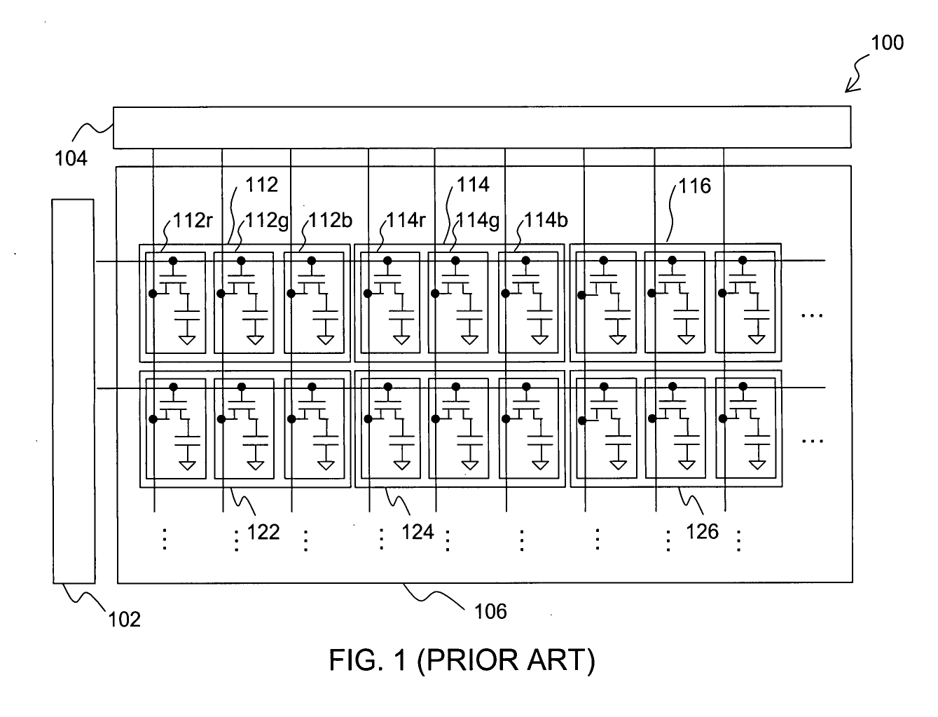

### DESCRIPTION OF EMBODIMENTS

The present invention will be described more fully hereinafter with reference to the accompanying drawings. This invention may, however, be embodied in many different forms and should not be construed as limited to the embodiments set forth herein. Like numbers refer to like elements throughout.

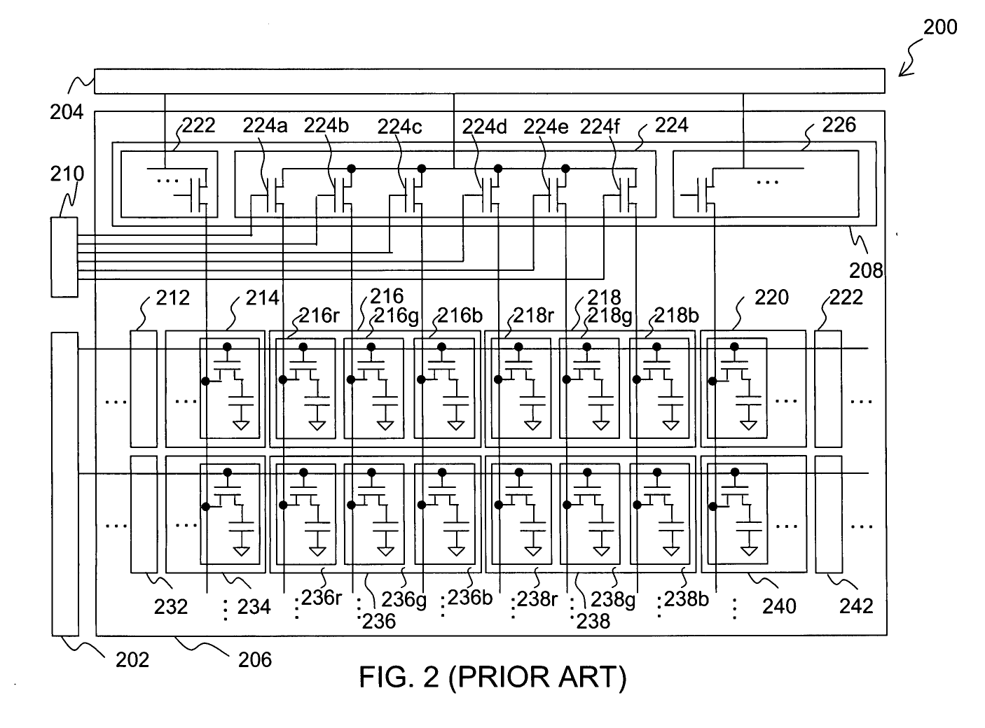

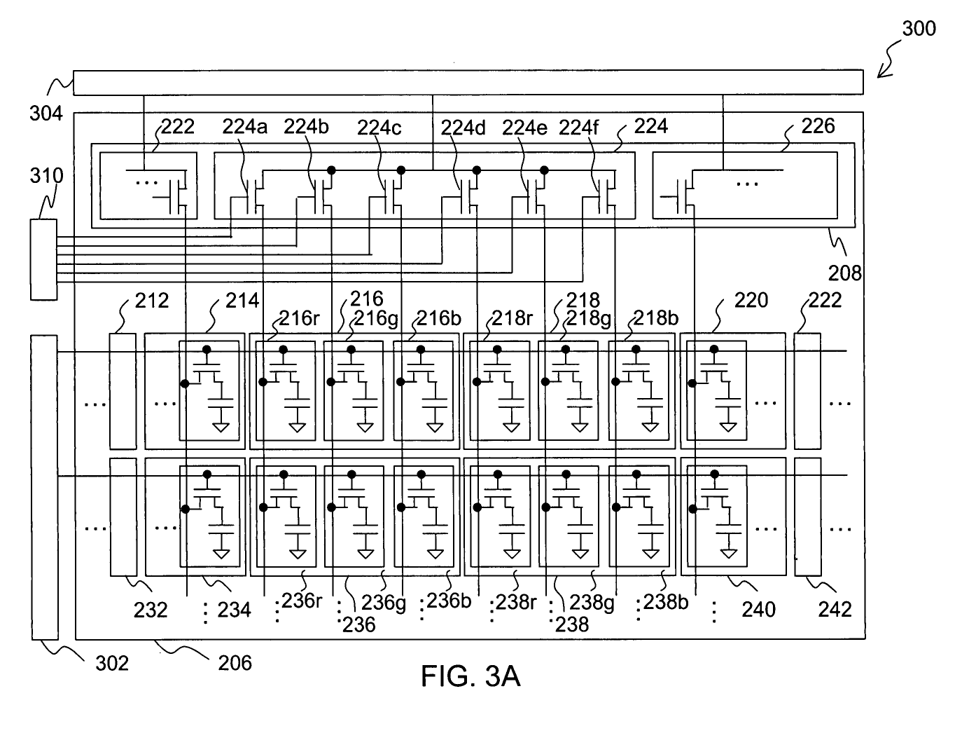

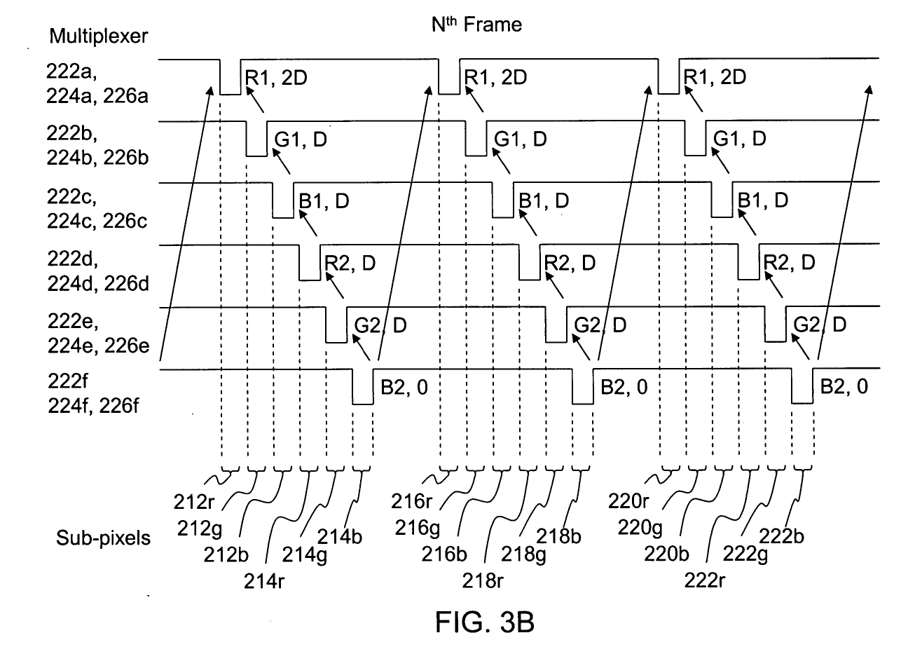

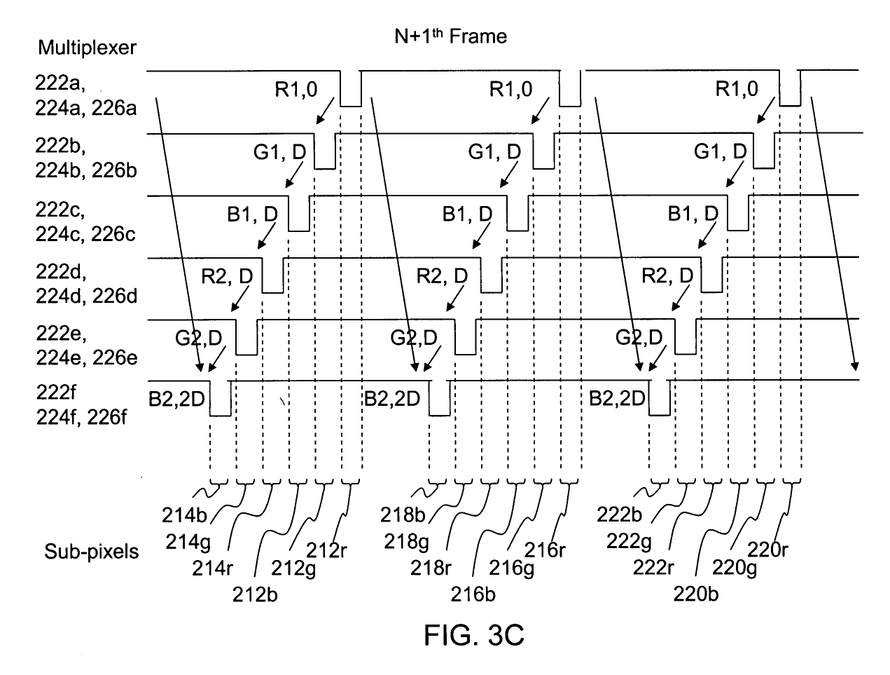

Refer to FIG. 3, which is a schematic view of a liquid crystal display device according to one embodiment of the present invention. In the embodiment, the liquid crystal display device 300 includes a control device 310 operated in a driving method different from the control device 200, a corresponding gate driver device 302, a source driver device 304 and a display area 206 that includes the same pixel architecture as the display area 206 shown in the FIG.2. With the driving method described below, the liquid crystal display device 300 could provide improvements in image uniformity.

FIG. 3B and FIG. 3C are timing diagrams of a driving method of the sub-pixels according to one embodiment of the present invention. For example, in any one of the scan lines (e.g., the first scan line), the timing sequence for turning on the TFTs in an N^{th} frame is shown as FIG. 3B, and in an N+1^{th} frame is shown as FIG. 3C. Referring to FIG. 3B, it is noted that the 6 sub-pixels of two adjacent pixels that are connected to the same multiplexer may be turned on for storing the corresponding data signals as a sequence of sub-pixels R1, G1, B1, R2, G2 and B2. For example, the sub-pixels R1, G1, B1 may represent the red, green and blue sub-pixels of the left side pixel (e.g., the pixel 212/216/220), and the sub-pixels R2, G2, B2 may represent the red, green and blue sub-pixels of the right side pixel (e.g., the pixel 214/218/222).

In FIG. 3B, the sub-pixels in the N^{th} frame may turned on as a sequence of R1, G1, B1, R2, G2, B2. It should be noted that, for any two adjacent sub-pixels, the one that is turned on later may be electrically coupled to the other. Therefore, the charges stored in the capacitor of the sub-pixel that is turned on later may be influenced by the other sub-pixel, wherein the amount of the influence is denoted as D. For example, sub-pixel 216r is electrically coupled to sub-pixels 214b and 216g. Sub-pixels 214b and 214g are turned on after sub-pixel 216r (indicated by the arrow from sub-pixels 214b to 216r and the arrow from sub-pixels 216g to 216r). Thus, the amount of the influence of the coupling of the sub-pixel 216r is represented as 2D. In addition, the sub-pixels 216g/216b/218r/218g are electrically coupled to the sub-pixels 216b/218r/218g/218b. The amount of the influence of the coupling of the sub-pixels 216g/216b/218r/218g is represented as D. Moreover, the sub-pixel 218b is turned on latest, and thus is not electrically coupled to any other sub-pixel. Thus, the amount of the influence of the coupling of the sub-pixel 218b is 0.

As described above, the amounts of the influence of the coupling of the red sub-pixels 212r, 214r, 216r, 218r, 220r and 222r in the N^{th} frame are 2D, D, 2D, D, 2D, D, respectively. Therefore, the brightness of the red sub-pixels in the whole LCD panel is not uniform. In addition, the amounts of the influence of the coupling of the blue sub-pixels 212b, 214b, 216b, 218b, 220b and 222b in the N^{th} frame are D, 0, D, 0, D, 0, respectively. Thus, the brightness of the blue sub-pixels in the whole LCD panel is also not uniform.

Referring to FIG. 3C, in the N+1^{th} frame, the timing sequence of the sub-pixels R1, G1, B1, R2, G2 and B2 is changed to be different from the N^{th} frame. In particular, in this embodiment, the sequence for turning on the TFTs is B2, G2, R2, B1, G1 and R1. Accordingly, the amounts of the influence of the coupling of the sub-pixels 216r, 216g, 216b, 218r, 218g and 218b in the N^{th} frame as shown in FIG. 3B are 2D, D, D, D, D, 0, respectively and in the N+1^{th} frame as shown in FIG. 3C are 0, D, D, D, D, 2D, respectively. Therefore, the average influences of the coupling of any two red sub-pixels, for example, the sub-pixels 216r and 218r in two adjacent frames, are the same. In addition, the average influences of the coupling of any two blue sub-pixels, for example, the sub-pixels 216b and 218b in two adjacent frames, are the same. Thus, the average brightness of any red/green/blue sub-pixels of the LCD panel in two adjacent frames is uniform.

In one embodiment of the present invention, the timing sequence for turning on the TFTs of the sub-pixels 212b, 214b, 216b, 218b, 220b and 222b, for example, the sequence R1, G1, B1, R2, G2 and B2 shown in FIG. 3B, and the sequence B2, G2, R2, B1, G1 and R1 shown in FIG. 3C is controlled by the control device 310 shown in FIG. 3A.

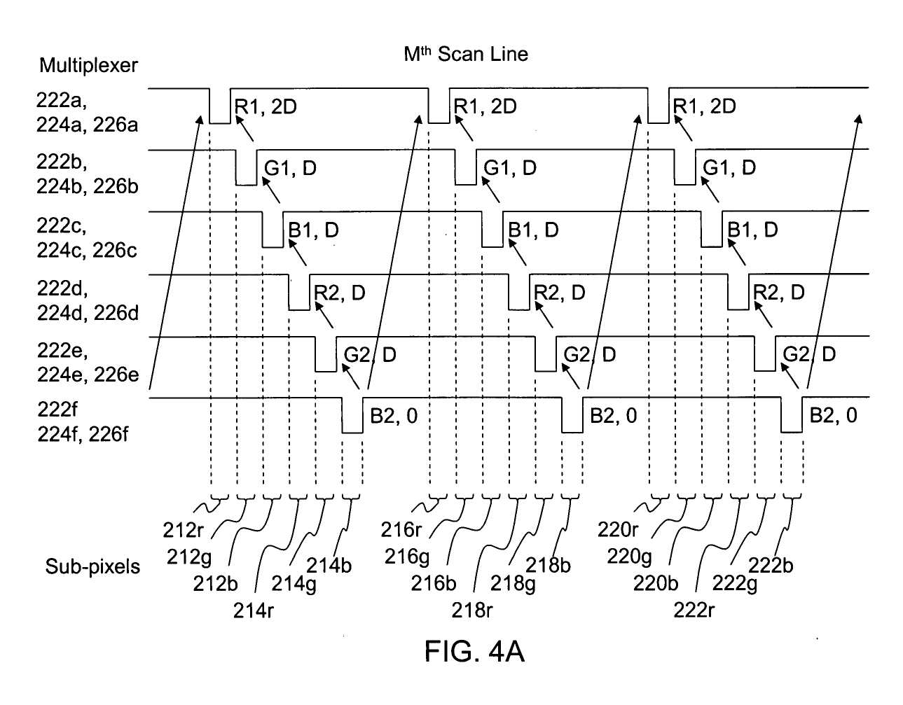

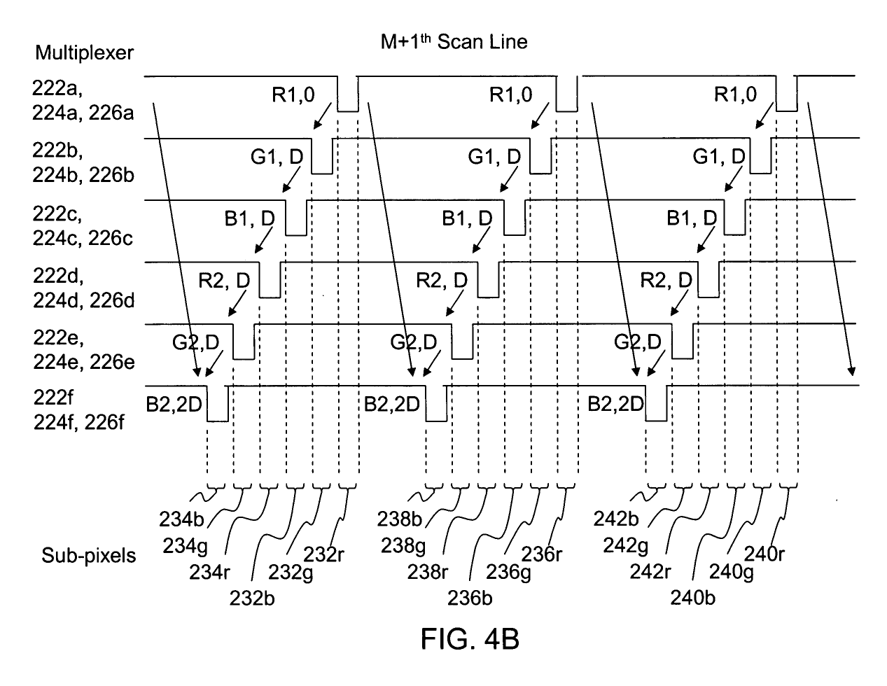

FIG. 4A and FIG. 4B are timing diagrams of a driving method of the sub-pixels according to another embodiment of the present invention. For example, in any frame, the timing sequence for turning on the TFTs connected to the M^{th} scan line is shown as FIG. 4A, and the timing sequence for turning on the TFTs connected to the M+1^{th} scan line is shown as FIG. 4B. Accordingly, the amounts of the influence of the coupling of the sub-pixels, for example, the sub-pixels 216r, 216g, 216b, 218r, 218g and 218b of the first scan line as shown in FIG. 4A are 2D, D, D, D, D, 0, respectively and that of the sub-pixels 236r, 236g, 236b, 238r, 238g and 238b of the second scan line that is adjacent to the first scan line as shown in FIG. 4B are 0, D, D, D, D, 2D, respectively. Therefore, in any frame, the average influences of the coupling of any two adjacent red sub-pixels, for example, the sub-pixel 216r on the M^{th} scan line and the sub-pixels 236r on the M+1^{th} scan line, are the same. In addition, the average influences of the coupling of any two adjacent blue sub-pixels, for example, the sub-pixel 216b on the M^{th} scan line and the sub-pixel 236b on the M+1^{th} scan line, are the same. Thus, the average brightness of two red/green/blue sub-pixels of the LCD panel on two adjacent scan lines is uniform.

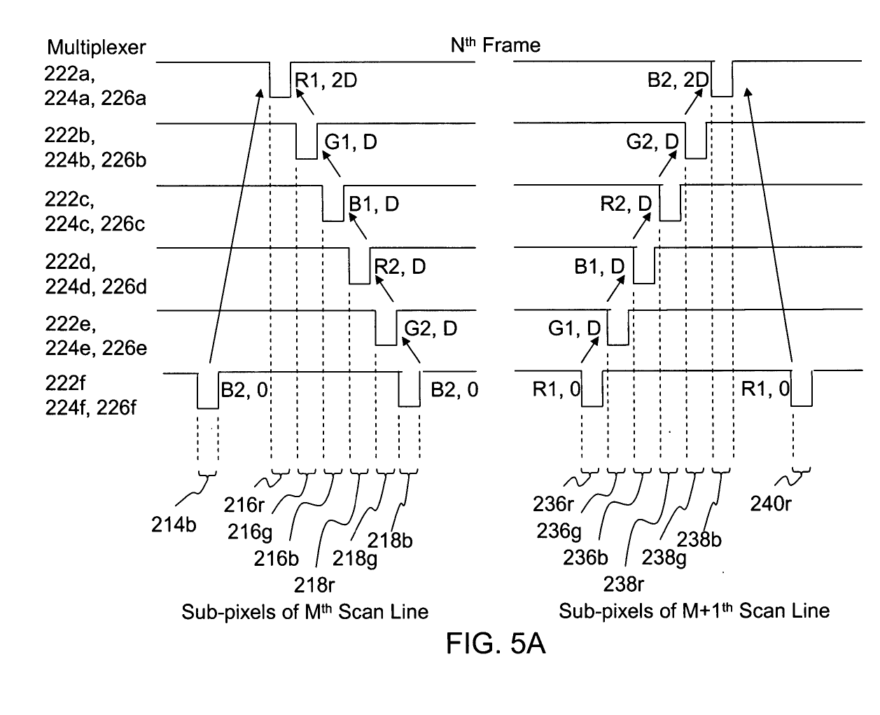

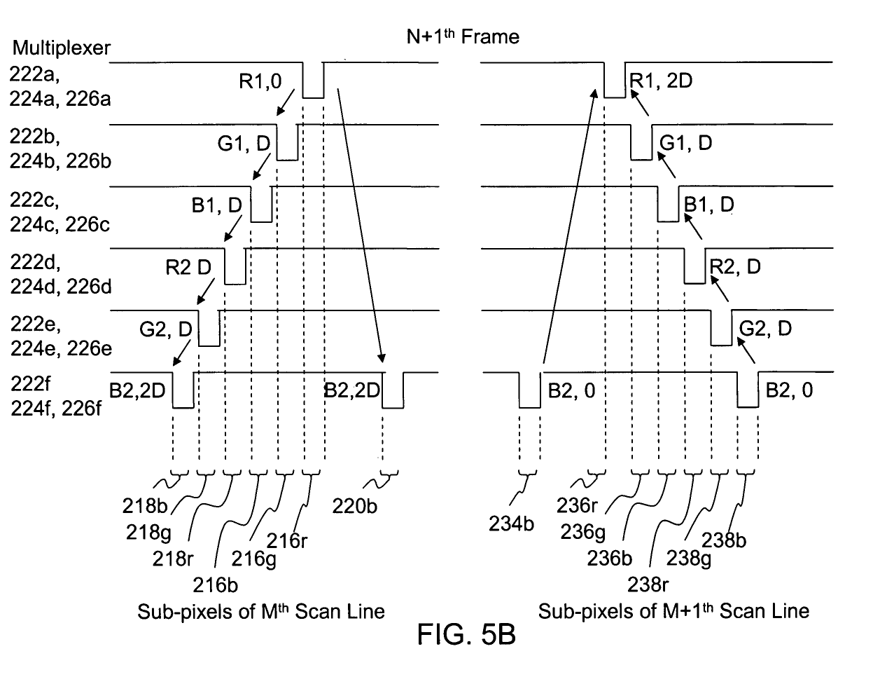

FIG. 5A and FIG. 5B are timing diagrams of a driving method of the sub-pixels according to another embodiment of the present invention. For example, the timing sequence for turning on the TFTs connected to the M^{th} and M+1^{th} scan lines in the N^{th} frame is shown as FIG. 5A, and the timing sequence for turning on the TFTs connected to the M^{th} and M+1^{th} scan lines in the N+1^{th} frame is shown as FIG. 5B. Accordingly, in the N^{th} and N+1^{th} frames, the average influences of the coupling of two red, green or blue sub-pixels on any two scan lines (i.e., the M^{th} and M+1^{th} scan lines) are the same. In addition, the average influences of the coupling of any red, green or blue sub-pixels in any two adjacent frames are the same. Thus, the average brightness of two red/green/blue sub-pixels of the LCD panel on two adjacent scan lines is uniform, and the average brightness of any red/green/blue sub-pixels of the LCD panel in two adjacent frames is also uniform.

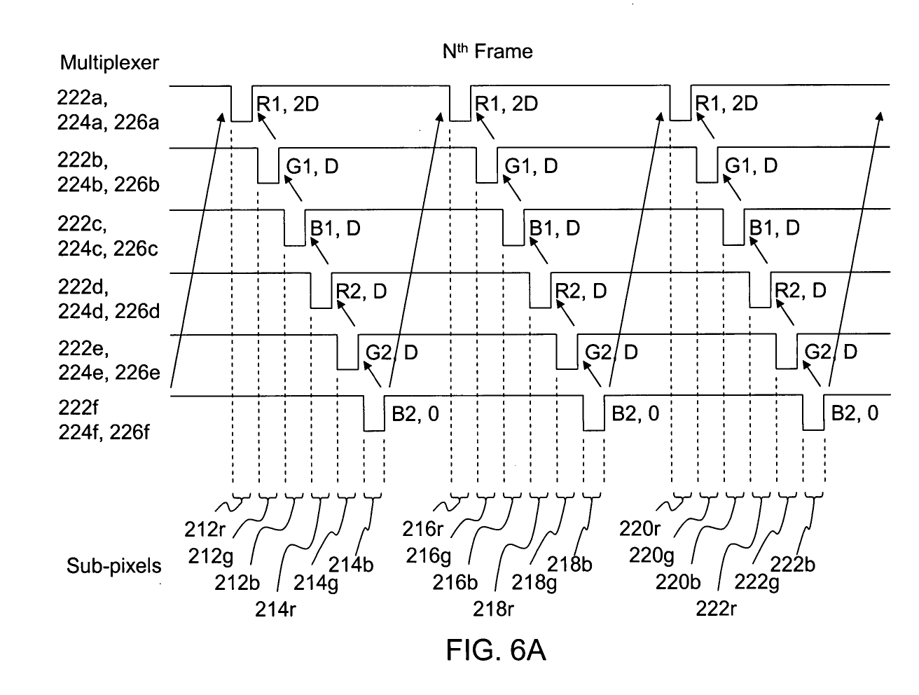

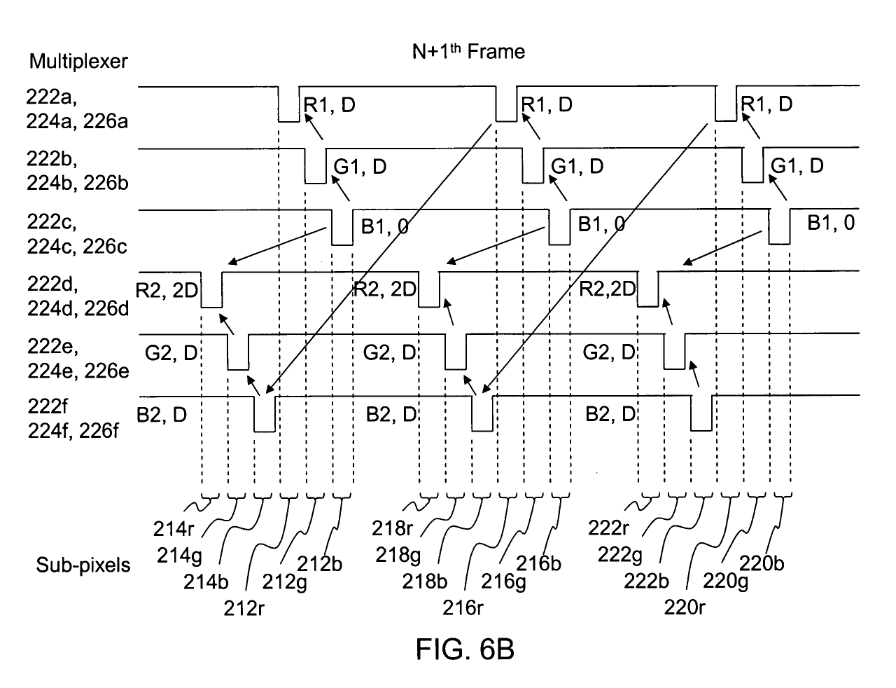

FIG. 6A and FIG. 6B are timing diagrams of a driving method of the sub-pixels according to another embodiment of the present invention. For example, in any one of the scan lines (e.g., the first scan line), the timing sequence for turning on the TFTs connected to the first scan line in an N^{th} frame is shown as FIG. 6A, and in a next N+1^{th} frame is shown as FIG. 6B. The sequence for turning on the TFTs of the sub-pixels shown in FIG. 6A may comprise R1, G1, B1, R2, G2 and B2, and that of the sub-pixels shown in FIG. 6B may comprise R2, G2, B2, R1, G and B1. Accordingly, the amounts of the influence of the coupling of the sub-pixels 216r, 216g, 216b, 218r, 218g and 218b in the N^{th} frame as shown in FIG. 6A are 2D, D, D, D, D, 0, respectively and in the N+1^{th} frame as shown in FIG. 6B are D, D, 0, 2D, D, D, respectively. Therefore, the average influences of the coupling of any two red sub-pixels, for example, the sub-pixels 216r and 218r in two adjacent frames, are the same. In addition, the average influences of the coupling of any two blue sub-pixels, for example, the sub-pixels 216b and 218b in two adjacent frames, are the same. Thus, the average brightness of any red/green/blue sub-pixels of the LCD panel in two adjacent frames is uniform.

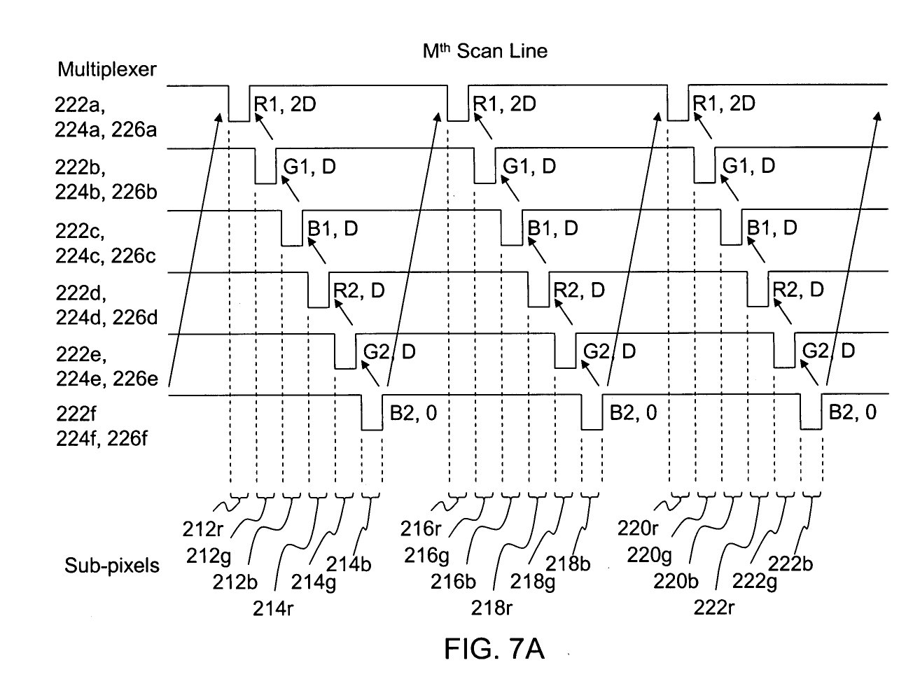

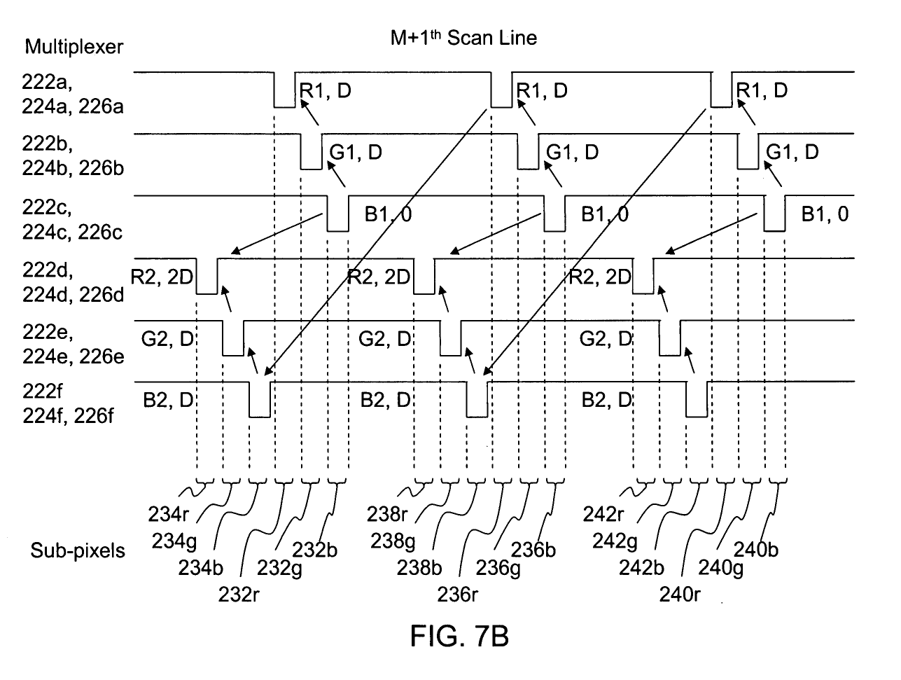

FIG. 7A and FIG. 7B are timing diagrams of a driving method of the sub-pixels according to another embodiment of the present invention. For example, in any frame, the timing sequence for turning on the TFTs connected to the M^{th} scan line is shown as FIG. 7A, and the timing sequence for turning on the TFTs connected to the M+1^{th} scan line is shown as FIG. 7B. Accordingly, the amounts of the influence of the coupling of the sub-pixels, for example, the sub-pixels 216r, 216g, 216b, 218r, 218g and 218b of the first scan line as shown in FIG. 7A are 2D, D, D, D, D, 0, respectively and that of the sub-pixels 236r, 236g, 236b, 238r, 238g and 238b of the second scan line that adjacent to the first scan line as shown in FIG. 7B are D, D, 0, 2D, D, D, respectively. Therefore, in any frame, the average influences of the coupling of any two adjacent red sub-pixels, for example, the sub-pixel 216r on the M^{th} scan line and the sub-pixels 236r on the M+1^{th} scan line, are the same. In addition, the average influences of the coupling of any two adjacent blue sub-pixels, for example, the sub-pixel 216b on the M^{th} scan line and the sub-pixel 236b on the M+1^{th} scan line are, the same. Thus, the average brightness of two red/green/blue sub-pixels of the LCD panel on two adjacent scan lines is uniform.

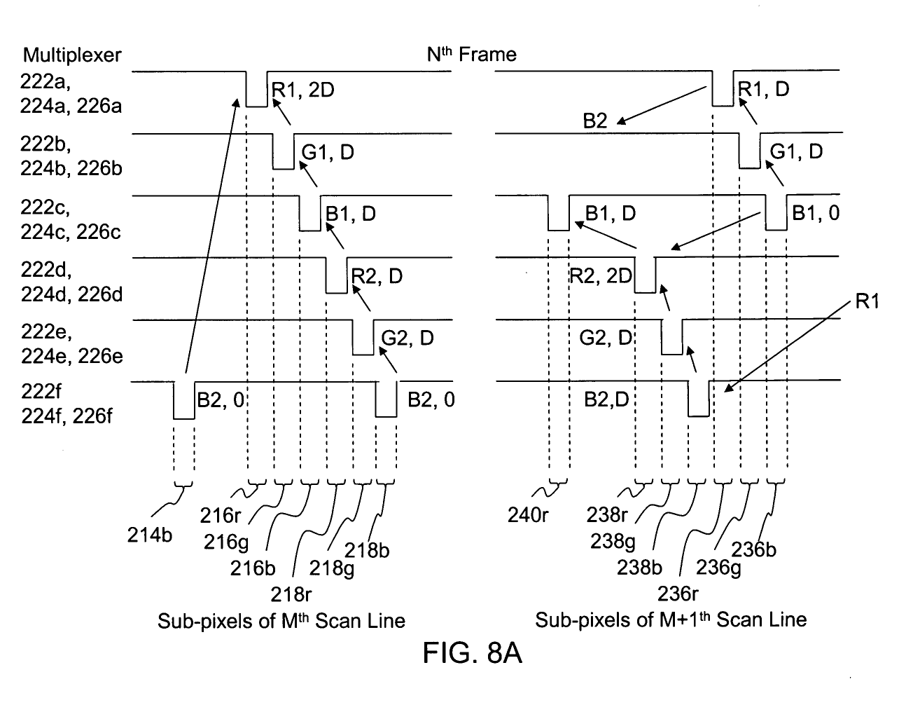

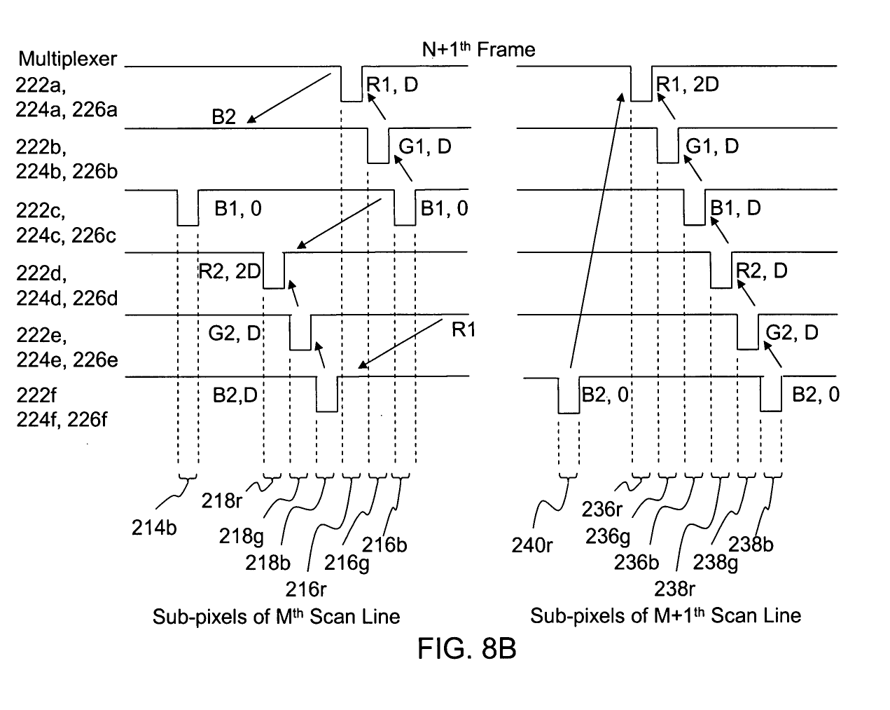

FIG. 8A and FIG. 8B are timing diagrams of a driving method of the sub-pixels according to another embodiment of the present invention. For example, the timing sequence for turning on the TFTs connected to the M^{th} and M+1^{th} scan lines in the N^{th} frame is shown as FIG. 8A, and the timing sequence for turning on the TFTs connected to the M^{th} and M+1^{th} scan lines in the N+1^{th} frame is shown as FIG. 8B. A Accordingly, in the N^{th} and N+1^{th} frames, the average influences of the coupling of two red, green or blue sub-pixels on any two scan lines (i.e., the M^{th} and M+1^{th} scan lines) are the same. In addition, the average influences of the coupling of any red, green or blue sub-pixels in any two adjacent frames are the same. Thus, the average brightness of two red/green/blue sub-pixels of the LCD panel on two adjacent scan lines is uniform, and the average brightness of any red/green/blue sub-pixels of the LCD panel in two adjacent frames is also uniform.

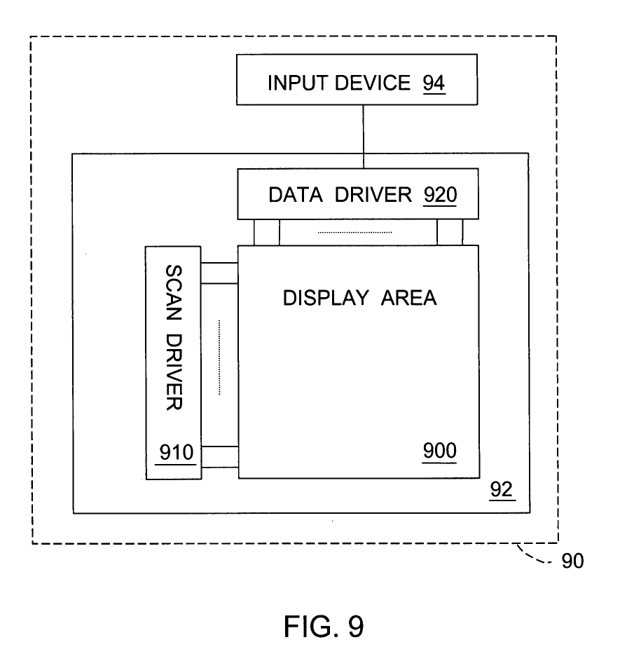

Referring to FIG. 9, a block diagram of an embodiment of an electronic device 90 is depicted. The electronic device 90 comprises a display device 92 and an input device 94. The input device 94 generates display data to the data driver 920. Accordingly, data driver 920 can send the display data to the display area 900 with proper operation of scan driver 910. Notably, the display device 92 uses a driving method such as provided in one of the embodiments described above.

Accordingly, an average influence of coupling of each of the sub-pixels in two adjacent frames is the same, and/or an average influence of coupling of two of the sub-pixels on two adjacent scan lines is the same by controlling the timing sequence. Thus, the average brightness of any red/green/blue sub-pixels of the LCD panel in two adjacent frames is uniform.

It will be apparent to those skilled in the art that various modifications and variations can be made to the above described embodiments without departing from the scope or spirit of the invention. In view of the foregoing, it is intended that the present invention cover modifications and variations of this invention provided they fall within the scope of the following claims and their equivalents.

What is claimed is:

1. A method for controlling a display panel, wherein the display panel comprises a plurality of pixels, wherein each of the plurality of pixels comprises a plurality of sub-pixels, the method comprising:
controlling a timing sequence for turning on the pixels such that at least one of: an average influence of coupling of each of the sub-pixels in two sequential time frames is the same; and an average influence of coupling of two of the sub-pixels on two adjacent rows of the sub-pixels is the same.

2. The method of claim 1, wherein each of the pixels comprises a red sub-pixel, a green sub-pixel and a blue sub-pixel, and sub-pixels R1, G1, B1 represent the red, green and blue sub-pixels of a first of the pixels , and the sub-pixels R2, G2, B2 represent the red, green and blue sub-pixels of a second of the pixels.

3. The method of claim 2, wherein the timing sequence for turning on the sub-pixels during a first time frame comprises R1, G1, B1, R2, G2, B2, and the timing sequence for turning on the sub-pixels during a second sequential time frame comprises B2, G2, R2, B1, G1, R1.

4. The method of claim 2, wherein the timing sequence for turning on the sub-pixels of a first scan line comprises R1,G1, B1, R2,, B2, and the timing sequence for turning on the sub-pixels of a second scan line adjacent to the first scan line comprises B2, G2, R2, B1, G1, R1.

5. The method of claim 4, wherein the timing sequence for turning on the sub-pixels during a first time frame comprises R1, G1, B1,R2, G2, B2, and the timing sequence for turning on the sub-pixels during a second sequential time frame comprises B2, G2, R2, B1, G1, R1.

6. The method of claim 2, wherein the timing sequence for turning on the sub-pixels during a first time frame comprises R1, G1, B1,R2, G2, B2, and the timing sequence for turning on the sub-pixels during a second sequential time frame comprises R2, G2, B2, R1, G1, B1.

7. The method of claim 2, wherein the timing sequence for turning on the sub-pixels during a first scan line comprises R1, G1, B1, R2, G2, B2, and the timing sequence for turning on the sub-pixels during a second sequential scan line comprises R2, G2, B2, R1, G1, B1.

8. The method of claim 7, wherein the timing sequence for turning on the sub-pixels during a first time frame comprises RI, G1, B1, R2, G2, B2, and the timing sequence for turning on the sub-pixels during a second sequential time frame comprises R2, G2, B2, R1, G1, B1.

9. A device, comprising:
a display device comprising a plurality of pixels, each of the plurality of pixels having sub-pixels, the display device being operative to illuminate the sub-pixels in accordance with a timing sequence, the timing sequence being configured such that at least one of:
an average influence of coupling of each of the sub-pixels in two sequential time frames is the same; and an average influence of coupling of two of the sub-pixels on two adjacent rows of the sub-pixels is the same.

10. The device of claim 9, further comprising:
an input device for generating display data such that the display device illuminates the sub-pixels responsive to the display data.

11. The device of claim 9, further comprising:
means for generating display data such that the display device illuminates the sub-pixels responsive to the display data.
